(19) United States
(12) Patent Application Publication
(10) Pub. No.: US 2019/0017451 A1
(43) Pub. Date: Jan. 17, 2019

(54) IGNITION TIMING CONTROL APPARATUS FOR INTERNAL COMBUSTION ENGINE

(71) Applicant: TOYOTA JIDOSHA KABUSHIKI KAISHA, Toyota-shi (JP)

(72) Inventors: Kenji SENDA, Okazaki-shi (JP); Rihito KANEKO, Miyoshi-shi (JP); Masaya SUNAGO, Toyota-shi (JP); Takayuki HOSOGI, Toyota-shi (JP); Norihito HANAI, Toyota-shi (JP); Hisayuki ITO, Toyota-shi (JP); Masaaki YAMAGUCHI, Okazaki-shi (JP)

(73) Assignee: TOYOTA JIDOSHA KABUSHIKI KAISHA, Toyota-shi (JP)

(21) Appl. No.: 16/031,705

(22) Filed: Jul. 10, 2018

(30) Foreign Application Priority Data
Jul. 13, 2017 (JP) 2017-137279

(51) Int. Cl. F02D 35/02; F02P 5/15; F02D 41/24

(52) U.S. Cl. CPC F02D 35/027; F02D 37/02; F02D 41/2464; F02P 5/1502

(57) ABSTRACT

An ignition timing control apparatus for an internal combustion engine includes an electronic control unit configured to i) perform determination as to whether knocking has occurred in the engine; ii) update a first learning value and a second learning value such that the ignition timing is retarded when determining that knocking has occurred; and iii) derive, as a required ignition timing, a timing obtained by retarding a base ignition timing based on the first and second learning values. The electronic control unit is configured to update the second learning value within a range in which an update amount of the second learning value within a prescribed period set in advance does not exceed a prescribed amount, when updating the second learning value.

### INCORPORATION BY REFERENCE

The disclosure of Japanese Patent Application No. 2017-137279 filed on Jul. 13, 2017 including the specification, drawings and abstract is incorporated herein by reference in its entirety.

### BACKGROUND

### 1. Technical Field

The disclosure relates to an ignition timing control apparatus for an internal combustion engine.

### 2. Description of Related Art

As an ignition timing control apparatus for an internal combustion engine, there is known an apparatus that determines, based on a detection signal from a knock sensor provided in an internal combustion engine, whether knocking has occurred in the internal combustion engine, and that adjusts the ignition timing based on a result of the determination. When it is determined that knocking has occurred in the internal combustion engine, this apparatus restrains the occurrence of knocking in the internal combustion engine, by retarding the ignition timing.

For example, in an apparatus described in Japanese Patent Application Publication No. 2009-30541 (JP 2009-30541 A), a settable most advanced ignition timing and a settable most retarded ignition timing are set based on an engine operating state, and a maximum retardation amount as a difference between the most advanced ignition timing and the most retarded ignition timing is calculated. This apparatus derives a feedback correction value for instantaneously adjusting the ignition timing based on a result of a determination as to whether knocking has occurred, and a knocking learning value for restraining the absolute value of the feedback correction value from becoming excessively large. The apparatus derives the sum of a difference obtained by subtracting the knocking learning value from the maximum retardation amount and the feedback correction value as an ignition timing retardation amount, which is an amount of retardation of the ignition timing from the most advanced ignition timing. Then, the apparatus derives a required ignition timing by subtracting the ignition timing retardation amount from the most advanced ignition timing.

The apparatus described in Japanese Patent Application Publication No. 2009-30541 (JP 2009-30541 A) derives the most retarded ignition timing as follows. That is, a deposit learning value is calculated as a value that is obtained taking into account an amount of deposits adhering to the internal combustion engine. This deposit learning value increases as the frequency with which it is determined that knocking has occurred increases. The most retarded ignition timing is set to be more retarded as the deposit learning value increases.

### SUMMARY

Other vibrations generated in the internal combustion engine as well as vibrations resulting from knocking are input to the knock sensor. Examples of the other vibrations include vibrations resulting from the operation of engine valves and vibrations resulting from reciprocating movements of pistons. Therefore, when it is determined whether knocking has occurred through the use of a detection signal from the knock sensor, it may be determined that knocking has occurred although knocking has not occurred in reality, because the other vibrations are input to the knock sensor. In this case as well, the ignition timing is retarded in the above-described ignition timing control apparatus.

In the case where it is erroneously determined that knocking has occurred due to the phenomenon in which the other vibrations are input to the knock sensor, even when the ignition timing is retarded, the phenomenon is not always eliminated. In the case where the phenomenon in which the other vibrations are input to the knock sensor is thus not eliminated even when the ignition timing is retarded, the ignition timing may continue to be retarded. In this case, the learning values are erroneously updated. As a result, the state where the ignition timing is excessively retarded cannot be eliminated, and it is difficult to increase the torque output from the internal combustion engine.

An aspect of the disclosure relates to an ignition timing control apparatus for an internal combustion engine including an electronic control unit configured to i) perform determination as to whether knocking has occurred in the internal combustion engine based on a detection signal from a knock sensor; ii) update a first learning value that compensates for a change in an ignition timing resulting from a factor other than a time-dependent change in the internal combustion engine, and a second learning value that compensates for a change in the ignition timing resulting from the time-dependent change in the internal combustion engine such that the ignition timing is retarded when the electronic control unit determines that knocking has occurred; and iii) derive, as a required ignition timing, a timing obtained by retarding a base ignition timing based on the first learning value and the second learning value. The electronic control unit is configured to update the second learning value within a range in which an update amount of the second learning value within a prescribed period set in advance does not exceed a prescribed amount, when updating the second learning value.

In the above-described aspect, the electronic control unit may be configured to i) update a feedback correction value based on a result of the determination as to whether knocking has occurred in the internal combustion engine; and ii) update the first learning value such that an absolute value of the feedback correction value is decreased, based on a part of a learning update amount that is based on the feedback correction value, and update the second learning value such that the absolute value of the feedback correction value is decreased, based on a rest of the learning update amount. The timing derived as the required ignition timing may be obtained by retarding the base ignition timing based on the feedback correction value, the first learning value, and the second learning value.

When it is determined that knocking has occurred in the internal combustion engine based on the detection signal from the knock sensor, the feedback correction value is updated, and the ignition timing is retarded. Further, the first learning value and the second learning value are updated based on the learning update amount, so as to decrease the absolute value of the feedback correction value. Then, the required ignition timing is more likely to be set to be retarded as each of the first learning value and the second learning value increases.

The second learning value is a value that compensates for the change in ignition timing resulting from the time-dependent change in the internal combustion engine. Therefore, the second learning value gradually increases as time passes. In other words, an increase in the second learning value within a short period is not preferred. For example, when the second learning value is set to a value indicating that the adhesion amount of deposits has become large to some extent even though the amount of deposits adhering to the internal combustion engine is not very large, it is difficult to make the ignition timing close to the base ignition timing, because the advancement of the ignition timing through feedback is limited. That is, it may become difficult to increase the torque output from the internal combustion engine.

Thus, in the above-described configuration, the update amount of the second learning value within the prescribed period does not exceed the prescribed amount. Therefore, within the above-described prescribed period, even when it is erroneously determined that knocking has occurred because vibrations other than vibrations resulting from knocking are input to the knock sensor, the second learning value can be restrained from becoming large within a short period. As a result, when the required ignition timing is derived based on the base ignition timing, the feedback correction value, and the first and second learning values, it is easy to make the required ignition timing close to the base ignition timing through feedback because the second learning value is unlikely to become large.

Accordingly, even when it is determined that knocking has occurred although knocking has not occurred in reality, it is possible to reduce the possibility that it becomes difficult to increase the torque output from the internal combustion engine.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a configuration view schematically showing an internal combustion engine provided with a control apparatus as an ignition timing control apparatus for an internal combustion engine according to an embodiment of the disclosure;

FIG. 2 is a schematic view showing a mode in which a required ignition timing is calculated;

FIG. 3 is a schematic view showing the distribution of a maximum retardation amount;

FIG. 4 is a view illustrating an engine operating region;

FIG. 5 is a block diagram showing the functional configuration of the control apparatus;

FIG. 6 is a flowchart illustrating a processing routine that is executed to set a limit value of an F/B correction value on a retardation side;

FIG. 7 is a flowchart illustrating a processing routine that is executed in calculating the F/B correction value and a learning update amount;

FIG. 8 is a flowchart illustrating a processing routine that is executed when learning values are calculated; and

FIG. 9 is a timing chart showing how the learning values and the ignition timing change.

### DETAILED DESCRIPTION OF EMBODIMENTS

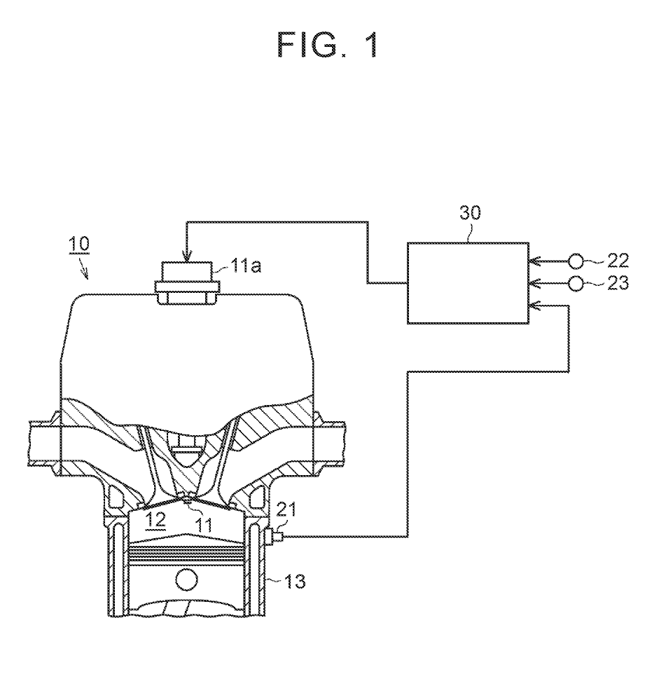

An ignition timing control apparatus for an internal combustion engine according to an embodiment of the disclosure will be described hereinafter with reference to FIGS. 1 to 9. FIG. 1 shows an internal combustion engine 10 provided with a control apparatus 30 as the ignition timing control apparatus according to the present embodiment of the disclosure. This internal combustion engine 10 is mounted in a vehicle. This vehicle travels with the internal combustion engine 10 serving as a power source.

As shown in FIG. 1, the internal combustion engine 10 includes an ignition plug 11. Also, in a combustion chamber 12 of the internal combustion engine 10, an air-fuel mixture containing intake air and fuel is burned by being ignited by the ignition plug 11. A cylinder block 13 of the internal combustion engine 10 is provided with a knock sensor 21 that detects occurrence of knocking resulting from the combustion of the air-fuel mixture. When vibrations are input to this knock sensor 21, the knock sensor 21 outputs a detection signal corresponding to the input vibrations to the control apparatus 30.

The control apparatus 30 performs various kinds of control regarding the operation of the internal combustion engine 10. The control apparatus 30 is an electronic control unit including a Central Processing Unit (CPU) that performs the various kinds of control and a memory in which information necessary for the control is stored. Detection signals are input to the control apparatus 30 from various sensors such as the knock sensor 21, a crank angle sensor 22, and a throttle sensor 23. The crank angle sensor 22 outputs a signal corresponding to an engine rotational speed NE as a rotational speed of a crankshaft. The throttle sensor 23 outputs a signal corresponding to a throttle opening degree TA.

The control apparatus 30 controls the operation of an actuator that is needed to perform engine control, based on the detection signals from the above-described various sensors 21 to 23. Examples of the actuator include an igniter 11a that generates a high-voltage current necessary for the ignition of the air-fuel mixture with the use of the ignition plug 11.

The control apparatus 30 performs knocking control for determining, based on the detection signal from the knock sensor 21, whether knocking has occurred in the internal combustion engine 10, deriving a required ignition timing eafin as a required value of an ignition timing based on a result of this determination, and driving the igniter 11a based on the required ignition timing eafin. As the required ignition timing eafin is set to be more retarded, the occurrence of knocking can be reduced.

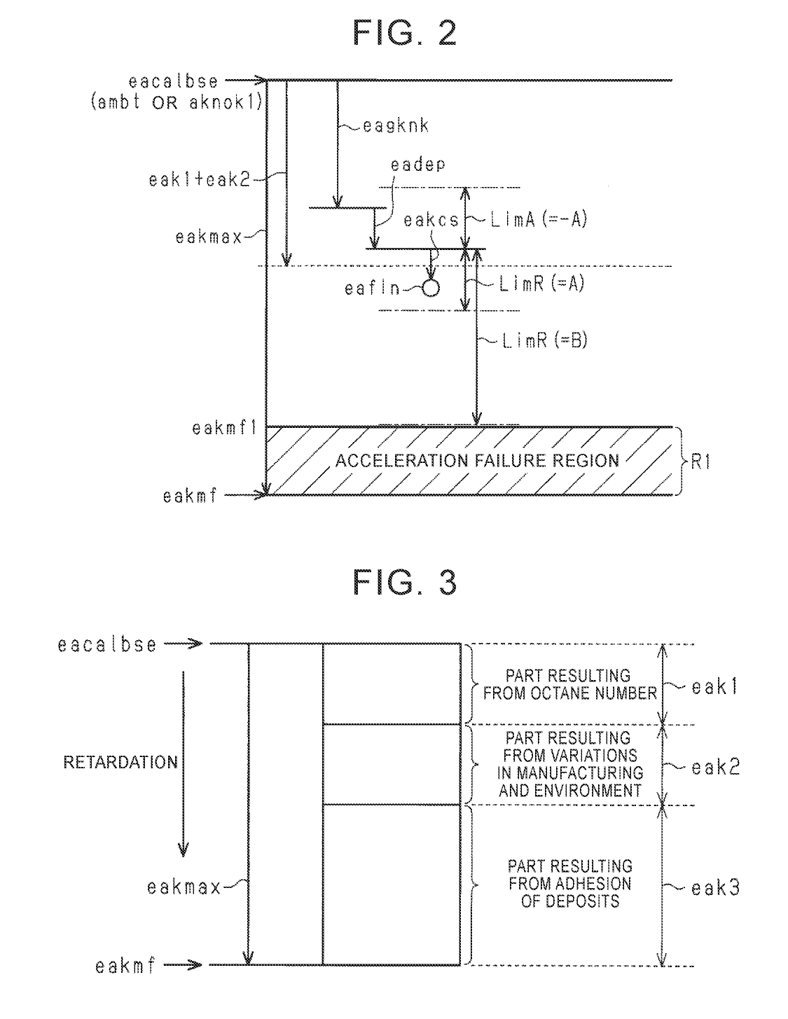

Next, the knocking control will be described with reference to FIG. 2. It should be noted herein that the ignition timing is expressed as an advancement amount (° CA) of a crank angle with respect to a compression top dead center of a cylinder in which the air-fuel mixture is to be ignited.

As shown in FIG. 2, the required ignition timing eafin is set based on a base ignition timing eacalbse, a feedback correction value (referred to as “an F/B correction value”) eakcs, an instantaneous component learning value eagknk as a first learning value, and a long-term component learning value eadep as a second learning value.

For example, the base ignition timing eacalbse is calculated based on an MBT point ambt and a first knock limit point aknok1. More specifically, the more retarded value of the MBT point ambt and the first knock limit point aknok1 is set as the base ignition timing eacalbse (i.e., the base ignition timing eacalbse is set to the more retarded value of the MBT point ambt and the first knock limit point aknok1). The MBT point ambt is a maximum torque ignition timing as an ignition timing at which a maximum torque can be obtained under a current engine operating condition. The first knock limit point aknok1 is a knock limit ignition timing as an advancement limit value of the ignition timing at which it is determined that knocking has not occurred under the assumed best condition when a high-octane fuel with a high knock limit is used. The MBT point ambt and the first knock limit point aknok1 are set based on the current engine rotational speed NE, a current engine load factor KL, and the like, with reference to a setting map stored in the memory of the control apparatus 30. For example, the engine load factor KL can be calculated based on the engine rotational speed NE and an intake air amount.

The F/B correction value eakcs is set in accordance with a result of a determination as to whether knocking has occurred. More specifically, when it is determined that knocking has not occurred, the F/B correction value eakcs is gradually reduced. On the other hand, when it is determined that knocking has occurred, the F/B correction value eakcs is gradually increased.

The instantaneous component learning value eagknk is a value that compensates for a change in ignition timing resulting from factors other than time-dependent changes in the internal combustion engine 10. Examples of the factors other than time-dependent changes in the internal combustion engine 10 include a difference in octane number between fuels in use, and a manufacturing error of components of the internal combustion engine 10 (an individual variation of the internal combustion engine 10). The long-term component learning value eadep is a value that compensates for a change in ignition timing resulting from time-dependent changes in the internal combustion engine 10. Examples of the time-dependent changes in the internal combustion engine 10 include the adhesion of deposits of carbon and the like to the internal combustion engine 10. Each of the learning values eagknk and eadep is calculated based on a learning update amount eakcssm. The learning update amount eakcssm is derived based on, for example, a first-order lag element of the F/B correction value eakcs. Then, the instantaneous component learning value eagknk is calculated based on part of the learning update amount eakcssm, and the long-term component learning value eadep is calculated based on the rest of the learning update amount eakcssm.

Also, the required ignition timing eafin is set to be equal to a timing obtained by correcting the base ignition timing eacalbse toward the retardation side (i.e., a timing obtained by retarding the base ignition timing eacalbse), based on the F/B correction value eakcs and the learning values eagknk and eadep. In the present embodiment of the disclosure, the F/B correction value eakcs is set to a positive value when the ignition timing is changed toward the retardation side (i.e., when the ignition timing is retarded), and is set to a negative value when the ignition timing is changed toward an advancement side (i.e., when the ignition timing is advanced). Therefore, the required ignition timing eafin is more likely to be set to be on the retardation side (i.e., more likely to be set to be retarded) as the F/B correction value eakcs increases. Each of the learning values eagknk and eadep is set to a value equal to or larger than “0”. Therefore, the required ignition timing eafin is more likely to be set to be retarded, namely, the required ignition timing eafin is more unlikely to be set to be advanced, as each of the learning values eagknk and eadep increases.

As shown in FIG. 2, the update of the F/B correction value eakcs is limited. That is, the F/B correction value eakcs is basically updated between a limit value LimA (=−A (A>0)) on the advancement side and a limit value LimR (=A) on the retardation side. It should be noted, however, that the limit value LimR on the retardation side is changed to a value larger than “A” (=B (B>A)) when the internal combustion engine 10 is operated in a specific operating region, as will be described later.

The most retarded ignition timing eakmf in FIG. 2 is a settable retardation-side limit value of the required ignition timing eafin. This most retarded ignition timing eakmf is a knock limit ignition timing as a limit of the ignition timing at which it is determined that knocking has not occurred, for example, even in the case where the amount of deposits adhering to the internal combustion engine 10 has reached an assumed maximum amount under the assumed worst condition when a low-octane fuel with a low knock limit is used. The most retarded ignition timing eakmf is set in consideration of the current engine rotational speed NE, the current engine load factor KL and the like.

As shown in FIG. 2, there is an acceleration failure region R1 between the most retarded ignition timing eakmf and a prescribed timing eakmf1 as a timing that is more advanced than the most retarded ignition timing eakmf. In the case where the ignition timing falls within the acceleration failure region R1, the acceleration performance of the vehicle may significantly decrease.

In the present embodiment of the disclosure, a maximum retardation amount eakmax as a difference obtained by subtracting the most retarded ignition timing eakmf from the base ignition timing eacalbse is distributed as shown in FIG. 3. That is, the maximum retardation amount eakmax includes an octane number-related maximum retardation amount eak1 as the maximum retardation amount resulting from the octane number of the fuel used in the internal combustion engine 10, an error-related maximum retardation amount eak2 as the maximum retardation amount resulting from, for example, a manufacturing error of the components of the internal combustion engine 10 (an individual variation of the internal combustion engine 10) and the environment in which the internal combustion engine 10 is used, and a deposit maximum retardation amount eak3 as the maximum retardation amount resulting from the adhesion of deposits to the internal combustion engine 10. Among these maximum retardation amounts eak1, eak2 and eak3, the octane number-related maximum retardation amount eak1 and the error-related maximum retardation amount eak2 are changes in ignition timing resulting from factors other than time-dependent changes in the internal combustion engine 10. On the other hand, the amount of deposits adhering to the internal combustion engine 10 is gradually increased as time passes. Therefore, the deposit maximum retardation amount eak3 is a change in ignition timing resulting from time-dependent changes in the internal combustion engine 10.

Thus, in the present embodiment of the disclosure, the instantaneous component learning value eagknk is a learning value whose upper limit is the sum of the octane number-related maximum retardation amount eak1 and the error-related maximum retardation amount eak2. On the other hand, the long-term component learning value eadep is a learning value whose upper limit is the deposit maximum retardation amount eak3.

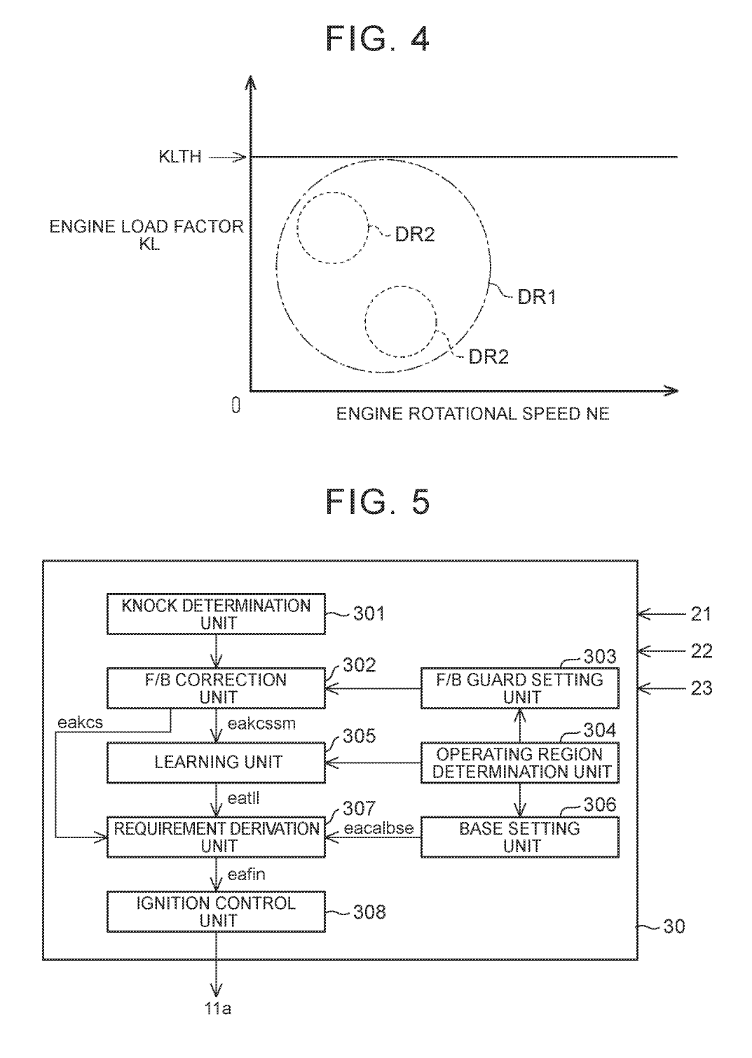

Next, the functional configuration of the control apparatus 30 will be described with reference to FIGS. 4 and 5. As shown in FIG. 5, the control apparatus 30 includes a knock determination unit 301, a feedback correction unit (hereinafter referred to as “an F/B correction unit”) 302, a feedback guard setting unit (hereinafter referred to as “an F/B guard setting unit”) 303, an operating region determination unit 304, a learning unit 305, a base setting unit 306, a requirement derivation unit 307, and an ignition control unit 308, as functional units configured to perform knocking control.

The knock determination unit 301 determines, based on a detection signal from the knock sensor 21, whether knocking has occurred in the internal combustion engine 10. For example, the knock determination unit 301 can acquire a mode of vibrations input to the knock sensor 21, and can determine, based on the mode of the vibrations, whether knocking has occurred.

The operating region determination unit 304 acquires the current engine rotational speed NE and the current engine load factor KL. Then, the operating region determination unit 304 determines, based on the acquired engine rotational speed NE and the acquired engine load factor KL, whether the engine is operated within a significant deposit influence region DR1 surrounded by an alternate long and short dash line in FIG. 4. The significant deposit influence region DR1 is a region where the possibility of the occurrence of knocking tends to be high due to the deposits adhering to the internal combustion engine 10, and is determined in advance through an experiment, a simulation or the like. In the present embodiment of the disclosure, this determination is also referred to as “a significant deposit influence determination”.

The operating region determination unit 304 also determines, based on a detection signal from the crank angle sensor 22 and a detection signal from the throttle sensor 23, whether the internal combustion engine 10 is operated at high load. For example, when the current engine load factor KL is equal to or higher than a criterial load factor KLTH as shown in FIG. 4, the operating region determination unit 304 can determine that the engine is operated at high load. In the present embodiment of the disclosure, this determination is referred to also as “a high-load operation determination”.

The base setting unit 306 calculates the above-described MBT point ambt and the above-described first knock limit point aknok1 based on the engine rotational speed NE and engine load factor KL acquired by the operating region determination unit 304. Then, the base setting unit 306 sets the more retarded value of the MBT point ambt and the first knock limit point aknok1 as the base ignition timing eacalbse (i.e., the base setting unit 306 sets the base ignition timing eacalbse to the more retarded value of the MBT point ambt and the first knock limit point aknok1).

The F/B guard setting unit 303 determines the limit value LimR of the F/B correction value eakcs on the retardation side, based on a result of the significant deposit influence determination performed by the operating region determination unit 304. The F/B correction unit 302 calculates the F/B correction value eakcs based on a result of the determination performed by the knock determination unit 301 and the limit value LimR set by the F/B guard setting unit 303. The F/B correction unit 302 also calculates the learning update amount eakcssm based on the F/B correction value eakcs.

The learning unit 305 calculates the instantaneous component learning value eagknk and the long-term component learning value eadep based on a result of the high-load operation determination performed by the operating region determination unit 304, and the learning update amount eakcssm calculated by the F/B correction unit 302. Then, the learning unit 305 calculates a total learning value eatll based on the calculated instantaneous component learning value eagknk and the calculated long-term component learning value eadep.

The requirement derivation unit 307 derives the required ignition timing eafin based on the base ignition timing eacalbse set by the base setting unit 306, the F/B correction value eakcs calculated by the F/B correction unit 302, and the total learning value eatll calculated by the learning unit 305. More specifically, the requirement derivation unit 307 derives the required ignition timing eafin through the use of a relational expression shown below (Expression 1). That is, the sum of the F/B correction value eakcs and the total learning value eatll is a retardation amount from the base ignition timing eacalbse. Accordingly, the required ignition timing eafin is set to be more retarded as the F/B correction value eakcs increases, and as the total learning value eatll increases. It should be noted, however, that the required ignition timing eafin is set to be equal to the most retarded ignition timing eakmf when the result of calculation obtained through the use of the relational expression 1 (Expression 1) is a value more retarded than the most retarded ignition timing eakmf.

eafin=eacalbse+(eakcs+eatll) (Expression 1)

The ignition control unit 308 controls the igniter 11a based on the required ignition timing eafin derived by the requirement derivation unit 307.

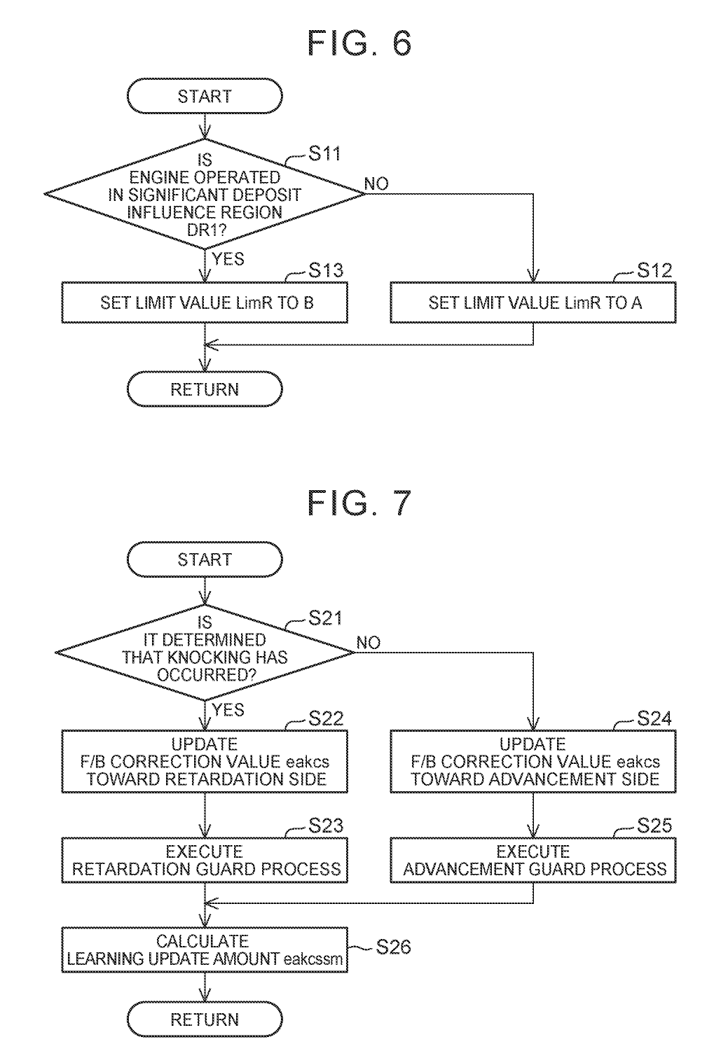

Next, a processing routine that is executed by the F/B guard setting unit 303 will be described with reference to FIG. 6. The present processing routine is executed in each control cycle set in advance. As shown in FIG. 6, in the present processing routine, when the operating region determination unit 304 determines that the engine is not operated in the significant deposit influence region DR1 (NO in step S11), the F/B guard setting unit 303 selects “A” as the limit value LimR of the F/B correction value eakcs on the retardation side (step S12). After that, the F/B guard setting unit 303 ends the present processing routine. When the operating region determination unit 304 determines that the engine is operated in the significant deposit influence region DR1 (YES in step S11), the F/B guard setting unit 303 selects “B” as the limit value LimR (step S13). That is, in step S13, the guard on the retardation side in calculating the F/B correction value eakcs is relaxed. After that, the F/B guard setting unit 303 ends the present processing routine.

Next, a processing routine that is executed by the F/B correction unit 302 will be described with reference to FIG. 7. The present processing routine is executed in each control cycle set in advance. As shown in FIG. 7, in the present processing routine, when the knock determination unit 301 determines that knocking has occurred in the internal combustion engine 10 (YES in step S21), the F/B correction unit 302 increases the F/B correction value eakcs, namely, updates the F/B correction value eakcs toward the retardation side (step S22). Then, the F/B correction unit 302 executes a retardation guard process for the F/B correction value eakcs. That is, in the retardation guard process, the F/B correction unit 302 sets the smaller one of the F/B correction value eakcs updated in step S22 and the limit value LimR (A or B) set by the F/B guard setting unit 303, as the F/B correction value eakcs (i.e., the F/B correction unit 302 sets the F/B correction value eakcs to the smaller one of the F/B correction value eakcs updated in step S22 and the limit value LimR (A or B) set by the F/B guard setting unit 303). After that, the F/B correction unit 302 shifts the process to step S26, which will be described later.

When the knock determination unit 301 determines that knocking has not occurred in the internal combustion engine 10 (NO in step S21), the F/B correction unit 302 reduces the F/B correction value eakcs, namely, updates the F/B correction value eakcs toward the advancement side (step S24). Then, the F/B correction unit 302 executes an advancement guard process for the F/B correction value eakcs. That is, in the advancement guard process, the F/B correction unit 302 sets the larger one of the F/B correction value eakcs updated in step S24 and the limit value LimA (=−A) on the advancement side shown in FIG. 2, as the F/B correction value eakcs (i.e., the F/B correction unit 302 sets the F/B correction value eakcs to the larger one of the F/B correction value eakcs updated in step S24 and the limit value LimA (=−A) on the advancement side shown in FIG. 2). After that, the F/B correction unit 302 shifts the process to step S26, which will be described later.

In step S26, the F/B correction unit 302 calculates the learning update amount eakcssm based on the first-order lag element of the F/B correction value eakcs. In the present embodiment of the disclosure, the F/B correction unit 302 sets the learning update amount eakcssm to a value equal to the first-order lag element of the F/B correction value eakcs. The learning update amount eakcssm may be a sum obtained by adding an offset value to the first-order lag element of the F/B correction value eakcs.

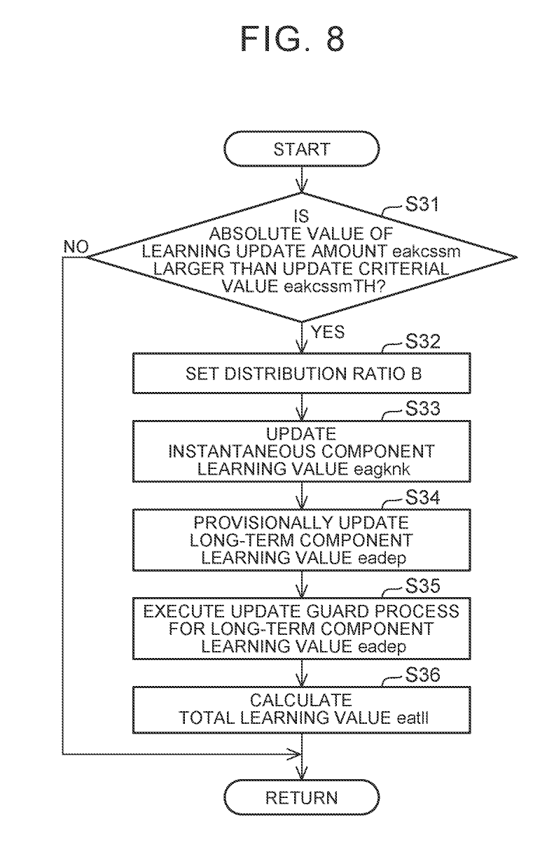

After that, the F/B correction unit 302 ends the present processing routine. Next, a processing routine that is executed by the learning unit 305 will be described with reference to FIG. 8. The present processing routine is executed in each control cycle set in advance.

As shown in FIG. 8, in the present processing routine, the learning unit 305 determines whether the absolute value of the learning update amount eakcssm calculated by the F/B correction unit 302 is larger than an update criterial value eakcssmTH (step S31). The update criterial value eakcssmTH is a value set as a criterion for determining whether to update the instantaneous component learning value eagknk and the long-term component learning value eadep. Therefore, the learning values eagknk and eadep are allowed to be updated when the absolute value of the learning update amount eakcssm is larger than the update criterial value eakcssmTH, whereas the learning values eagknk and eadep are prohibited from being updated when the absolute value of the learning update amount eakcssm is equal to or smaller than the update criterial value eakcssmTH.

Then, when the absolute value of the learning update amount eakcssm is equal to or smaller than the update criterial value eakcssmTH (NO in step S31), the learning unit 305 ends the present processing routine. When the absolute value of the learning update amount eakcssm is larger than the update criterial value eakcssmTH (YES in step S31), the learning unit 305 sets a distribution ratio B (step S32). That is, when the operating region determination unit 304 determines that the engine is operated at high load, the learning unit 305 makes the distribution ratio B equal to “1”. When the operating region determination unit 304 determines that the engine is not operated at high load, the learning unit 305 sets the distribution ratio B to a value equal to “α”. The value “α” is larger than “0” and smaller than “1”. For example, in the present embodiment of the disclosure, “α” is “0.5”. The value “α” may be different from “0.5” (e.g., 0.3 or 0.7).

Subsequently, the learning unit 305 updates the instantaneous component learning value eagknk (step S33). That is, the learning unit 305 calculates the instantaneous component learning value eagknk based on the learning update amount eakcssm and the distribution ratio B. For example, the instantaneous component learning value eagknk is calculated based on a relational expression shown below (Expression 2). In the relational expression (Expression 2), “eagknkA” is the instantaneous component learning value eagknk at a time point when the execution of the current processing routine is started.

eagknk=eagknkA+(eakcssm×B) (Expression 2)

In step S33, when a result of calculation obtained through the use of the relational expression (Expression 2) is a positive value, the learning unit 305 compares the absolute value of the sum of the octane number-related maximum retardation amount eak1 and error-related maximum retardation amount eak2 shown in FIG. 3 with the absolute value of the instantaneous component learning value eagknk calculated through the use of the relational expression (Expression 2). Then, when the absolute value of the instantaneous component learning value eagknk is larger than the absolute value of the sum, the learning unit 305 sets the sum as the instantaneous component learning value eagknk (i.e., the learning unit 305 sets the instantaneous component learning value eagknk to the sum). When the absolute value of the instantaneous component learning value eagknk is equal to or smaller than the absolute value of the sum, the learning unit 305 sets the result of calculation obtained through the use of the relational expression (Expression 2) as the instantaneous component learning value eagknk (i.e., the learning unit 305 sets the instantaneous component learning value eagknk to the result of calculation obtained through the use of the relational expression (Expression 2) without changing the result of calculation). When the result of calculation obtained through the use of the relational expression (Expression 2) is a negative value, the learning unit 305 makes the instantaneous component learning value eagknk equal to “0”.

Then, the learning unit 305 provisionally updates the long-term component learning value eadep (step S34). That is, the learning unit 305 calculates the long-term component learning value eadep based on the learning update amount eakcssm and the distribution ratio B. For example, the long-term component learning value eadep is calculated based on a relational expression shown below (Expression 3). In the relational expression (Expression 3), “eadep A” is the long-term component learning value eadep at a time point when the execution of the current processing routine is started.

eadep=eadepA+(eakcssm×(1−B)) (Expression 3)

In step S34, when a result of calculation obtained through the use of the relational expression (Expression 3) is a positive value, the learning unit 305 compares the absolute value of the deposit maximum retardation amount eak3 shown in FIG. 3 with the absolute value of the long-term component learning value eadep calculated through the use of the relational expression (Expression 3). Then, when the absolute value of the long-term component learning value eadep is larger than the absolute value of the deposit maximum retardation amount eak3, the learning unit 305 sets the long-term component learning value eadep to a value equal to the deposit maximum retardation amount eak3. When the absolute value of the deposit maximum retardation amount eak3 is equal to or smaller than the absolute value of the long-term learning value eadep, the learning unit 305 sets the result of calculation obtained through the use of the relational expression (Expression 2) as the long-term component learning value eadep (i.e., the learning unit 305 sets the long-term component learning value eadep to the result of calculation obtained through the use of the relational expression (Expression 2) without changing the result of calculation). When the result of calculation obtained through the use of the relational expression (Expression 3) is a negative value, the learning unit 305 makes the long-term component learning value eadep equal to “0”.

Subsequently, the learning unit 305 executes an update guard process for the long-term component learning value eadep (step S35). As described above, the long-term component learning value eadep is a learning value that is obtained taking into account the adhesion of deposits to the internal combustion engine 10. Therefore, in the present embodiment of the disclosure, the update of the long-term component learning value eadep within a prescribed period TM is limited. That is, the learning unit 305 corrects the long-term component learning value eadep calculated in step S34 such that an update amount Δeadep of the long-term component learning value within the prescribed period TM does not exceed a prescribed amount ΔeadepTH. For example, when the update amount Δeadep of the long-term component learning value within the prescribed period TM is smaller than the prescribed amount ΔeadepTH, the result of calculation in step S34 is set as the long-term component learning value eadep (i.e., the long-term component learning value eadep is set to the result of calculation in step S34 without changing the result of calculation in step S34). When the update amount Δeadep is equal to or larger than the prescribed amount ΔeadepTH, the sum obtained by adding the prescribed amount ΔeadepTH to the long-term component learning value eadep at a time point when the prescribed period TM starts is set as the long-term component learning value eadep (i.e., the long-term component learning value eadep is set to the sum obtained by adding the prescribed amount ΔeadepTH to the long-term component learning value eadep at the time point when the prescribed period TM starts).

The prescribed amount ΔeadepTH is set to a value satisfying both a condition that the prescribed amount ΔeadepTH is sufficiently smaller than the above-described deposit maximum retardation amount eak3 and a condition that the prescribed amount ΔeadepTH is sufficiently smaller than the sum of the octane number-related maximum retardation amount eak1 and the error-related maximum retardation amount eak2. The prescribed amount ΔeadepTH may be set to a value satisfying the condition that the prescribed amount ΔeadepTH is smaller than the sum of the octane number-related maximum retardation amount eak1 and the error-related maximum retardation amount eak2.

It should be noted herein that the prescribed period TM is defined as a period up to a time point when a travel distance of the vehicle resulting from the transmission of a torque output from the internal combustion engine 10 to driving wheels of the vehicle reaches a prescribed travel distance. The prescribed travel distance is a value that is set taking into account a rate of increase in the amount of deposits adhering to the internal combustion engine 10 and the prescribed amount ΔeadepTH. If the engine is operated such that the ignition timing continues to be retarded, the long-term component learning value eadep is updated by the prescribed amount ΔeadepTH at the interval of the prescribed period TM. That is, the long-term component learning value eadep is gradually updated in accordance with the gradual increase in the amount of deposits adhering to the internal combustion engine 10.

Subsequently, the learning unit 305 calculates the total learning value eatll (step S36). That is, the learning unit 305 compares the sum of the instantaneous component learning value eagknk updated in step S33 and the long-term component learning value eadep updated in step S35 with a retardation guard value Y. Then, the learning unit 305 sets the smaller one of the sum of the instantaneous component learning value eagknk and the long-term component learning value eadep and the retardation guard value Y as the total learning value eatll (i.e., the learning unit 305 sets the total learning value eatll to the smaller one of the sum of the instantaneous component learning value eagknk and the long-term component learning value eadep, and the retardation guard value Y). After that, the learning unit 305 ends the present processing routine.

The retardation guard value Y is incremented by a predetermined amount, for example, when a period during which the total learning value eatll continues to be equal to the retardation guard value Y reaches a period equivalent to the product of N (N is a positive number equal to or larger than 1) and the prescribed period TM. The retardation guard value Y is decremented by a predetermined amount, for example, when a period during which the total learning value eatll continues to be smaller than the retardation guard value Y reaches a criterial period. In this case, the sum of the octane number-related maximum retardation amount eak1 and the error-related maximum retardation amount eak2 is set as an initial value of the retardation guard value Y (i.e., an initial value of the retardation guard value Y is set to the sum of the octane number-related maximum retardation amount eak1 and the error-related maximum retardation amount eak2).

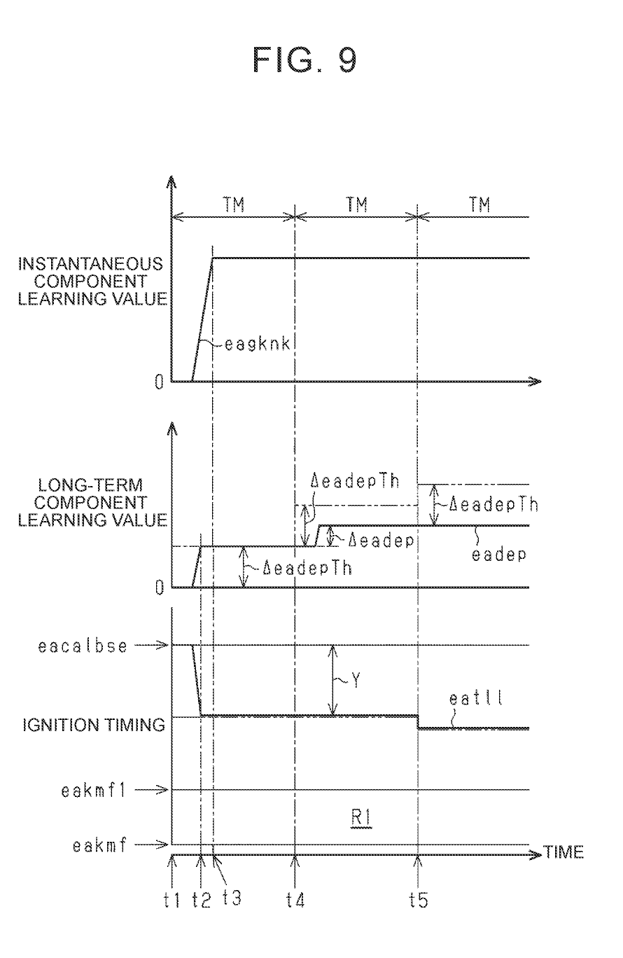

Next, the operation and effect in the case where it is determined that knocking has occurred in a situation where the engine is not operated at high load will be described with reference to FIGS. 4 and 9. When knocking occurs in the internal combustion engine 10, vibrations resulting from knocking are input to the knock sensor 21. Then, the control apparatus 30 determines that knocking has occurred. Therefore, the F/B correction value eakcs is increased, and the ignition timing is retarded. This retardation of the ignition timing is carried out until it is determined that knocking has not occurred. Thus, the occurrence of knocking can be restrained.

Vibrations resulting from factors other than knocking in the internal combustion engine 10 may be input to the knock sensor 21. If the mode of vibrations input to the knock sensor 21 at this time is similar to the mode of vibrations input to the knock sensor 21 at the time of the occurrence of knocking, the control apparatus 30 may determine that knocking has occurred although knocking has not occurred.

The vibrations leading to such an erroneous determination are likely to be caused when the engine is operated in a specific operating region. That is, in operating regions DR2 surrounded by broken lines in FIG. 4, vibrations with a large amplitude are likely to be input to the knock sensor 21 due to the occurrence of resonance in the internal combustion engine 10. As a result, it is erroneously determined that knocking has occurred although knocking has not occurred in reality. In the present embodiment of the disclosure, even when this erroneous determination is made, the F/B correction value eakcs is increased, and the ignition timing is retarded. However, even when the ignition timing is thus retarded, the amplitude of vibrations input to the knock sensor 21 does not become small. That is, it is continuously determined that knocking has occurred.

As a result, the F/B correction value eakcs continues to be increased, and the absolute value of the learning update amount eakcssm calculated based on the first-order lag element of the F/B correction value eakcs becomes larger than the update criterial value eakcssmTH. Then, the instantaneous component learning value eagknk and the long-term component learning value eadep are increased.

In the case where the engine continues to be operated in the operating regions DR2, even when the instantaneous component learning value eagknk and the long-term component learning value eadep are thus updated, the F/B correction value eakcs continues to be increased. Therefore, as shown in FIG. 9, the instantaneous component learning value eagknk and the long-term component learning value eadep also continue to be updated (increased).

As a result, as shown in FIG. 9, the update amount Δeadep of the long-term component learning value eadep reaches the prescribed amount ΔeadepTH at a timing t2 within the certain prescribed period TM (i.e., within the prescribed period TM from a timing t1 to a timing t4). Therefore, the long-term component learning value eadep is stopped from being updated (increased in this case) at and after the timing t2 within the certain prescribed period TM. That is, even when the engine continues to be operated in the above-described operating regions DR2 and it is erroneously determined that knocking has occurred although knocking has not occurred, the long-term component learning value eadep is restrained from becoming excessively large within a short period.

Therefore, when the engine is operated outside the operating regions DR2 afterward and it is determined that knocking has not occurred, the ignition timing can be made close to the base ignition timing eacalbse, by reducing the F/B correction value eakcs, because the long-term component learning value eadep has not become excessively large. Accordingly, it is possible to reduce the possibility that it becomes difficult to increase the output of the internal combustion engine 10. That is, it is possible to reduce the possibility that it is difficult to accelerate the vehicle.

Even in the case where the update of the long-term component learning value eadep is thus limited, the limit value LimR of the F/B correction value eakcs on the retardation side is increased. Therefore, even when the update of the long-term component learning value eadep is limited, the ignition timing can be retarded to the most retarded ignition timing eakmf as necessary, by increasing the F/B correction value eakcs.

Even in the case where the long-term component learning value eadep is stopped from being increased as described above, when a subsequent prescribed period TM (the prescribed period from the timing t4 to the timing t5) starts after a prescribed period TM (the prescribed period from the timing t1 to the timing t4) ends, the long-term component learning value eadep can be updated again within a range in which the update amount Δeadep of the long-term component learning value does not exceed the prescribed amount ΔeadepTH. Accordingly, the long-term component learning value eadep can be appropriately updated in accordance with the increase in the amount of deposits adhering to the internal combustion engine 10.

In the present embodiment of the disclosure, the total learning value eatll is prevented from becoming larger than the above-described retardation guard value Y. In the example shown in FIG. 9, the total learning value eatll is maintained to be equal to the retardation guard value Y within the prescribed period TM from the timing t1 to the timing t4. Therefore, the required ignition timing eafin is unlikely to be set within the acceleration failure region R1.

It should be noted, however, that when the total learning value eatll continues to be equal to the above-described retardation guard value Y for a long time, the F/B correction value eakcs may be large, and the required ignition timing eafin may be close to the most retarded ignition timing eakmf. Thus, in the present embodiment of the disclosure, when the total learning value eatll continues to be equal to the above-described retardation guard value Y for a long time, the retardation guard value Y is corrected to be increased (at the timing t5). Thus, the total learning value eatll can be increased. Accordingly, even in the case where a timing obtained by greatly retarding the base ignition timing eacalbse is set as the required ignition timing eafin (i.e., even in the case where the required ignition timing eafin is set to a timing obtained by greatly retarding the base ignition timing eacalbse), it is easy to eliminate the state where the absolute value of the F/B correction value eakcs is large.

The above-described embodiment of the disclosure may be changed into other embodiments of the disclosure that will be described below. In the above-described embodiment of the disclosure, the prescribed period TM is a period up to the time point when the travel distance of the vehicle reaches the prescribed travel distance, but the disclosure is not limited thereto. For example, the prescribed period TM may be a period up to a time point when the total operating time of the internal combustion engine 10 reaches a prescribed time.

The limit value LimR of the F/B correction value eakcs on the retardation side may be set to “B” only when the engine is operated in the operating regions DR2 shown in FIG. 4. Otherwise, the limit value LimR may be set to “A”.

The instantaneous component learning value eagknk may be stopped from being updated when the engine is operated in the operating regions DR2. The long-term component learning value eadep is stopped from being updated when the engine is operated in the operating regions DR2.

The limit value LimR of the F/B correction value eakcs on the retardation side may be fixed to “A” regardless of the operating region in which the engine is operated. Even when the engine is not operated at high load, the distribution ratio B may be set to “1” until the instantaneous component learning value eagknk reaches a changeover criterial value, and the distribution ratio B may be set to “α” after the instantaneous component learning value eagknk reaches the changeover criterial value. In this case, the changeover criterial value may be set to be equal to or smaller than the sum of the octane number-related maximum retardation amount eak1 and error-related maximum retardation amount eak2 shown in FIG. 3, as long as the changeover criterial value is a positive value.

Even when the sum of the instantaneous component learning value eagknk and the long-term component learning value eadep is larger than the retardation guard value Y, the total learning value eatll may be set to be equal to the sum.

What is claimed is:

1. An ignition timing control apparatus for an internal combustion engine, comprising an electronic control unit configured to
i) perform determination as to whether knocking has occurred in the internal combustion engine based on a detection signal from a knock sensor;
ii) update a first learning value that compensates for a change in an ignition timing resulting from a factor other than a time-dependent change in the internal combustion engine, and a second learning value that compensates for a change in the ignition timing resulting from the time-dependent change in the internal combustion engine such that the ignition timing is retarded when the electronic control unit determines that knocking has occurred; and
iii) derive, as a required ignition timing, a timing obtained by retarding a base ignition timing based on the first learning value and the second learning value, wherein
the electronic control unit is configured to update the second learning value within a range in which an update amount of the second learning value within a prescribed period set in advance does not exceed a prescribed amount, when updating the second learning value.

2. The ignition timing control apparatus according to claim 1, wherein:
the electronic control unit is configured to
i) update a feedback correction value based on a result of the determination as to whether knocking has occurred in the internal combustion engine; and
ii) update the first learning value such that an absolute value of the feedback correction value is decreased, based on a part of a learning update amount that is based on the feedback correction value, and update the second learning value such that the absolute value of the feedback correction value is decreased, based on a rest of the learning update amount, wherein
the timing derived as the required ignition timing is obtained by retarding the base ignition timing based on the feedback correction value, the first learning value, and the second learning value.

3. The ignition timing control apparatus according to claim 1, wherein the time-dependent change in the internal combustion engine is adhesion of deposits to the internal combustion engine.

4. The ignition timing control apparatus according to claim 1, wherein:
an upper limit of the first learning value is a sum of an octane number-related maximum retardation amount and an error-related maximum retardation amount; and
the prescribed amount is a value smaller than the sum of the octane number-related maximum retardation amount and the error-related maximum retardation amount.
